(19) United States
(12) Patent Application Publication
(10) Pub. No.: US 2002/0036053 A1
(43) Pub. Date: Mar. 28, 2002

(54) Wrapping material having surface ornamentation for wrapping holiday items

(76) Inventors: Donald E. Weder, Highland, IL (US); Sonny K. Burnside, St. Louis, MO (US)

Correspondence Address: Richard A. Nelson, Dunlap, Codding & Rogers, P.C., Suite 420, 9400 North Broadway, Oklahoma City, OK, 73114, US

(21) Appl. No.: 10/003,371

(22) Filed: Nov. 15, 2001

Related U.S. Application Data
(62) Division of application No. 09/460,208, filed on Dec. 13, 1999.
Application No. 09/460,208 is a continuation of application No. 09/061,426, filed on Apr. 16, 1998, now abandoned.

(51) Int. Cl. B65C 1/00

(52) U.S. Cl. 156/213; 156/212

(57) ABSTRACT

A decorative cover or wrapping formed from a sheet of material having design indicia thereon for wrapping a holiday item such as an easter egg or a holiday ornament, which may include forming indicia and an extension which is integral or non-integral to the sheet of material which is used as at least a portion of the decoration. Methods of decoratively covering easter eggs and holiday ornaments.

### CROSS REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

This invention generally relates to decorative covers and wrappings provided for holiday ornaments and easter eggs, and methods of using same.

2. Description of Related Art Including Information Disclosed Under 37 CFR §1.97 and 37 CFR §1.98

Easter eggs and holiday ornaments, collectively referred to herein, at times, as “holiday items”, have traditionally been items decorated and utilized around or for a holiday. Easter eggs have been colored and had various decorations placed on them. Holiday ornaments have been formed many different ways.

Candy eggs have been wrapped, to keep the candy fresh and uncontaminated. Holiday ornaments are usually preformed in any number of shapes.

Therefore, there is a need felt within the art for a wrapping which permits an easy and quick way to provide an outward decorative appearance for these holiday items, and even provide a way to take one item for one holiday and, via a decorative wrapping wrapped about such a holiday item, transform the item decoratively to provide a decorative element for a different holiday. Such a wrapping may also provide customized features, such as, but not by way of limitation, the recipient's name. In addition, there is a need for a wrapping which can be used to wrap a holiday item both quickly and easily. Such a decorative wrapping may provide wrapping instructions on one side of the sheet of material, to make it easy for a user. The wrapping will have at least one design indicia on one surface. The wrapping may utilize a bonding material, to effect an easy and complete closure about the holiday item. Such a wrapping may have extensions which extend therefrom for an additional aesthetic and decorative effect. The wrapping may utilize extensions as part of the wrapping, or may utilize a separate sheet of material for the extension(s). Further, such extensions may have shape sustaining elements. And, closure decorations may be utilized, to create a “finished effect” for the overall decoration. Such closure decorations may include, for example, but are not limited to, cotton balls, hats, jewelry, scarves, buttons, eyes, nose, ears, hair, clothing, and the like.

It is a goal of the present invention to provide a wrapping having a design indicia thereon to permit a user to quickly and easily wrap a holiday item. It is an objective of the present invention to provide a wrapping material having design indicia thereon which, when wrapped about an easter egg or a holiday ornament, provides a customize decoration of the easter egg or holiday ornament. It is a further goal of the present invention to provide a wrapping material having a design indicia thereon, and which has an extension integrally or non-integrally connected thereto which extends a distance from the wrapping. Such a wrapping material and extension provide a more multidimensional decorative effect for an easter egg or a holiday ornament. It is a further objective of the present invention to provide a wrapping which permits an ornament for one holiday to be transformed into an ornament for a different holiday. It is a further goal of the present invention to provide a wrapping having wrapping instructions on at least one surface. It is a further object of the present invention to provide a wrapping having a bonding material thereon, to effect an easy and complete closure about the holiday item. It is a further goal of the present invention to provide a shape sustaining element which may be included in the primary wrapping and/or may be included in any additional sheet of material utilized. And, it is a further objective of the present invention to utilize closure decorations, which may be utilized to complete and/or compliment the overall decoration of the holiday item (easter egg of holiday ornament).

### BRIEF SUMMARY OF THE INVENTION

The present invention defines a decorative cover for a holiday item. The decorative cover is made from a sheet of material having an upper surface, a lower surface and an outer periphery. At least one surface of the sheet of material has forming indicia thereon, and at least one other surface has design indicia thereon. A holiday item is disposed on the sheet of material via instructions provided by the forming indicia. The sheet of material is wrapped about the holiday item such that the holiday item is substantially surrounded and enclosed by the sheet of material thereby forming a decorative cover for the holiday item.

The holiday item may be an easter egg or a holiday ornament. The sheet of material forming the decorative cover may have a bonding material thereon. The bonding material may be an adhesive bonding material, or alternatively, a cohesive bonding material.

The sheet of material may comprise at least one extension. The extension may comprise a shape sustaining element. One additional sheet of material may be connected to the sheet of material to form at least one extension. The extension formed by the additional sheet of material may also have a shape sustaining element. The decorative cover further comprises a closure decoration as well.

The sheet of material used for the decorative cover is selected from the group consisting of paper, polymer film, fiber, foil, cellophane, cloth, burlap, and any combination thereof. The sheet of material has a thickness in a range from about 0.1 mils to about 10 mils, but, alternatively, may have a range from about 0.1 mils to about 5 mils.

The present invention also discloses a method of providing and wrapping a holiday item in a decorative cover. A sheet of material is provided, the sheet of material having an upper surface, a lower surface and an outer periphery. At least one surface of the sheet of material has forming indicia thereon and at least one other surface has design indicia thereon. A holiday item is provided, and disposed on the surface having forming indicia thereon. The holiday item is positioned via forming instructions, and the sheet of material is wrapped about the holiday item such that the holiday item is substantially surrounded and enclosed by the sheet of material thereby forming a decorative cover for the holiday item.

The holiday item provided may be an easter egg or a holiday ornament. The sheet of material provided which forms the decorative cover may have a bonding material thereon. The bonding material provided may be an adhesive bonding material, or alternatively, a cohesive bonding material.

The sheet of material provided may comprise at least one extension. The extension provided may also comprise a shape sustaining element. One additional sheet of material may be provided, and connected to the sheet of material to form at least one extension. The extension formed by the additional sheet of material may also have a shape sustaining element. The decorative cover may also be provided with a closure decoration as well.

The sheet of material provided is selected from the group consisting of paper, polymer film, fiber, foil, cellophane, cloth, burlap, and any combination thereof. The sheet of material provided has a thickness in a range from about 0.1 mils to about 10 mils, but, alternatively, may have a range from about 0.1 mils to about 5 mils.

### BRIEF DESCRIPTION OF THE SEVERAL VIEWS OF THE DRAWINGS

FIG. 1 is a perspective view of a sheet of material having one corner turned up for illustration purposes only and constructed in accordance with the present invention, showing a decorative indicia on the upper surface.

FIG. 2 is a top plan view of the lower surface of the sheet of material of FIG. 1, illustrating the forming indicia.

FIG. 3 is a perspective view of the lower surface of the sheet of material of FIGS. 1-2, showing an egg disposed on the forming indicia.

FIG. 4 is a bottom plan view of the lower surface of the sheet of material of FIGS. 1-3, showing an egg being partially wrapped.

FIG. 5 is a rear plan view of the egg and sheet of material shown in FIG. 4, but showing a completely wrapped egg.

FIG. 6 is a front plan view of the wrapped egg of FIG. 5, showing the design indicia on the egg.

FIG. 7 is a perspective view of another embodiment of the sheet of material of FIG. 1, showing extensions in the sheet of material, the arms and legs of the design being cut out from the sheet of material.

FIG. 8 is a perspective view of the lower surface of the sheet of material of FIG. 1, illustrating the forming indicia.

FIG. 9 is a perspective view of the lower surface of the sheet of material of FIGS. 7-8, showing an egg disposed on the forming indicia.

FIG. 10 is a perspective view of the sheet of material of FIGS. 7-9 after being wrapped about an egg, showing the overlapped portions of the sheet of material forming the wrapping, and showing a wrapped egg with extensions extending away from the wrapping.

FIG. 11 is a perspective view of the wrapped egg of FIG. 10, showing the design indicia with the extensions extending away from the wrapping.

FIG. 12 is a top plan view of yet another embodiment of the present invention, showing a sheet of material having design indicia (a “rabbit”) on the upper surface thereof, one edge lifted for illustration purposes only.

FIG. 13 is a top plan view of an additional sheet of material which forms an extension, the extension having its own design indicia (“rabbit ears”).

FIG. 14 is a top plan view of the lower surface of the sheet of material of FIG. 12, illustrating the forming indicia.

FIG. 15 is a perspective view of the lower surface of the sheet of material of FIGS. 12 and 14, showing an egg disposed on the forming indicia.

FIG. 16 is a rear plan view of the wrapped side of the egg of FIG. 15.

FIG. 17 is a side elevational view of the wrapped egg, showing the design indicia thereon, and showing the additional sheet of material forming an extension (“rabbit ears”) of FIG. 13 attached to the wrapped egg.

FIG. 18 is a side elevational view of the wrapped egg of FIG. 17, but showing a closure decoration (a “rabbit tail”) disposed on the wrapping.

FIG. 19 is a top plan view of still another embodiment of the present invention, showing a sheet of material having design indicia (a “rabbit”) on the upper surface thereof, one edge lifted for illustration purposes only.

FIG. 20 is a top plan view of an additional sheet of material which forms an extension, the extension having its own design indicia (“rabbit ears”), showing a shape sustaining element thereon.

FIG. 21 is a top plan view of the lower surface of the sheet of material of FIG. 19, illustrating the forming indicia.

FIG. 22 is a perspective view of the lower surface of the sheet of material of FIGS. 19 and 21, showing an egg disposed on the forming indicia.

FIG. 23 is a top plan view of the wrapped side of the egg of FIG. 22.

FIG. 24 is a side elevational view of the wrapped egg showing the design indicia thereon, and showing the additional sheet of material forming an extension (“rabbit ears”) of FIG. 20 attached to the wrapped egg, the shape sustaining element in the additional sheet of material permitting positioning of the extension (“rabbit ears”).

FIG. 25 is a side elevational view of the wrapped egg of FIG. 24, but showing a closure decoration (a “rabbit tail”) disposed on the wrapping.

FIG. 26 is a top plan view of still a further embodiment of the present invention, showing a sheet of material having design indicia (a man's face, the face having a mustache) on the upper surface thereof, one edge lifted for illustration purposes only.

FIG. 27 is a perspective view of a closure decoration (a western-style hat) having a bonding material disposed on a portion thereof.

FIG. 28 is a top plan view of the lower surface of the sheet of material of FIG. 26, illustrating the forming indicia.

FIG. 29 is a perspective view of the lower surface of the sheet of material of FIGS. 26 and 28, showing an egg disposed on the forming indicia.

FIG. 30 is a top plan view of the wrapped side of the egg of FIG. 29.

FIG. 31 is a front elevational view of the wrapped egg showing the design indicia thereon, and showing the closure decoration (the western-style hat) attached to the wrapped egg.

### DETAILED DESCRIPTION OF THE INVENTION

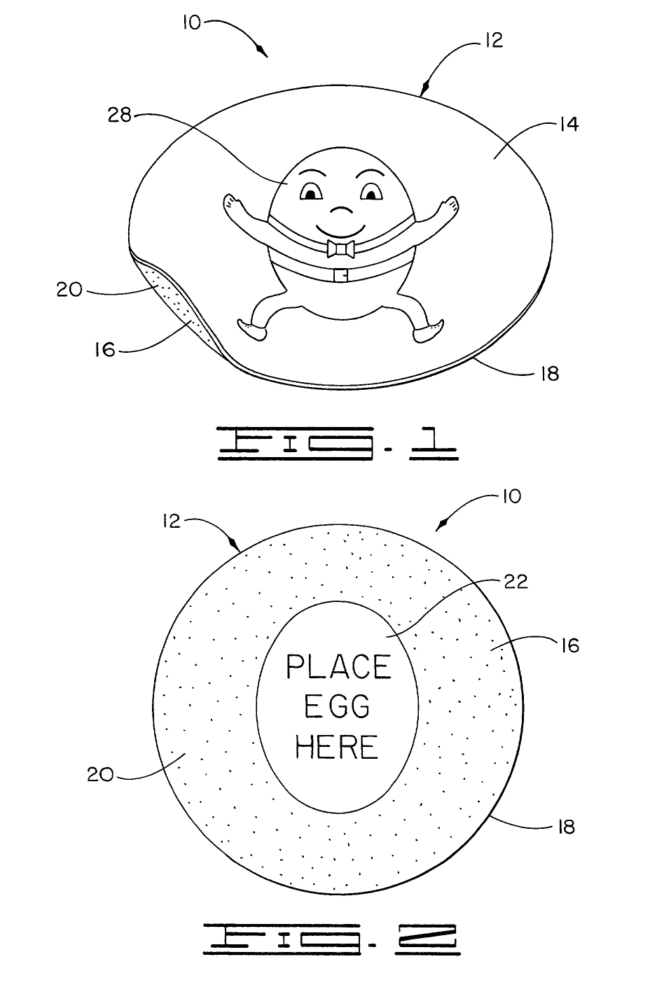

### The Embodiments of FIGS. 1-6

Easter eggs and holiday ornaments have existed for a number of years. A common problem with such ornaments is in easily decorating easter eggs, or, alternatively, customizing or changing an existing easter egg or holiday ornament to an ornament for a different occasion or holiday.

The present invention contemplates a wrapping material comprising at least a sheet of material having design indicia thereon. The sheet of material is wrapped about the easter egg and/or holiday ornament to decorate the easter egg or holiday ornament, or to change and/or customize the decoration of the easter egg or the holiday ornament. Additional features, characteristics, goals and objectives of the present invention are discussed above, and will be discussed in further detail below.

Referring now to FIGS. 1-6, designated therein by the general reference numeral 10 is a wrapping material for wrapping easter eggs and holiday ornaments. It will be appreciated that easter eggs and holiday ornaments are referred to, at times herein collectively as “holiday items”. The wrapping material 10 comprises at least one sheet of material 12. The sheet of material 12 has an upper surface 14, a lower surface 16, and an outer periphery 18, and in the present embodiment is shown having a round shape. It will be appreciated that the outer periphery 18, in some embodiments, will have a plurality of sides. The sheet of material 12 is substantially flat.

The sheet of material 12 also frequently has a bonding material 20 disposed on at least one surface of the sheet of material 12. “Bonding material”, as used herein, frequently means an adhesive bonding material, often a pressure sensitive adhesive, or, alternatively, a cohesive bonding material. Where the bonding material is a cohesive bonding material, a similar cohesive bonding material must be placed on the adjacent surface for bondingly contacting and bondingly engaging with the cohesive material.

The term “bonding material” also includes materials which are heat sealable and, in this instance, the adjacent portions of the material must be brought into contact and then heat must be applied to effect the seal. The term “bonding material” also includes materials which are sonicly sealable and vibratorally sealable. The term “bonding material” when used herein also means a lacquer. In some instances, a sealing lacquer is utilized, which may be applied to the sheet of material and, in this instance, heat, sound waves, or vibrations, also must be applied to effect and create the sealing.

The bonding material 20 utilized in the present invention may be disposed on the upper surface 14 of the sheet of material 12 or alternatively, on the lower surface 16 of the sheet of material 12 (not shown), or, in a further alternative, on both. The bonding material 20 is disposed on the sheet of material 12 by any means and/or methods of disposing a bonding material 20 on a sheet of material 12 known in the art, such as, but not by way of limitation, painting the bonding material 20 on the sheet of material 12, spraying the bonding material 20 on the sheet of material 12, immersing the sheet of material 12 in the bonding material 20, and the like. These means and methods of disposing a bonding material on a sheet of material are commercially available. As shown in FIG. 1, the bonding material 20 is often disposed on the lower surface 16 of the sheet of material 12. The bonding material 20 may be disposed in a plurality of strips of bonding material 20. It will be understood, however, that the bonding material 20 also could be applied to either surface of the sheet of material 12, or both surfaces, in the form of spaced apart spots of bonding material 20, or in any pattern, shape, or groups of patterns or shapes. That is, the bonding material 20 may comprise any geometric or non-geometric form and in any pattern, including covering at least one entire surface of the sheet of material 12.

The sheet of material 12 may also comprises forming indicia 22 thereon. “Forming indicia”, as used herein, includes, but not by way of limitation, score lines, creases and/or other printed indicia including printed instructions, letters, numbers, drawings, and the like, unprinted indicia, or any combination thereof. The forming indicia may comprise a pattern, or, in the alternative, the lack of a pattern, on a sheet of material having a pattern in other locations.

Turning again to the sheet of material 12 shown in FIGS. 1-3, the sheet of material 12 has a thickness in a range from about 0.1 mils to about 30 mils. Often, the sheet of material 12 has a thickness in a range from about 0.1 mils to about 5 mils. And, frequently, the sheet of material 12 has a thickness in a range from about 0.2 miles to about 3.5 mils. The sheet of material 12 is constructed of a material which is flexible.

The sheet of material 12 may be any shape and a round shape is shown in FIGS. 1-6 only by way of example. The sheet of material 12 may be rectangular, square or any other geometric shape, or any non-geometric shape, or any combination of geometric and non-geometric and/or asymmetric shapes.

The sheet of material 12 may be constructed of a single layer of material or a plurality of layers of the same or different types of materials. Any thickness of the sheet of material 12 may be utilized in accordance with the present invention as long as the sheet of material 12 is wrappable about an object, such as an easter egg or a holiday ornament, or a form to create a holiday ornament, such as, but not by way of limitation, a styrofoam form, as described herein. The layers of material comprising the sheet of material 12 may be connected together or laminated or may be separate layers.

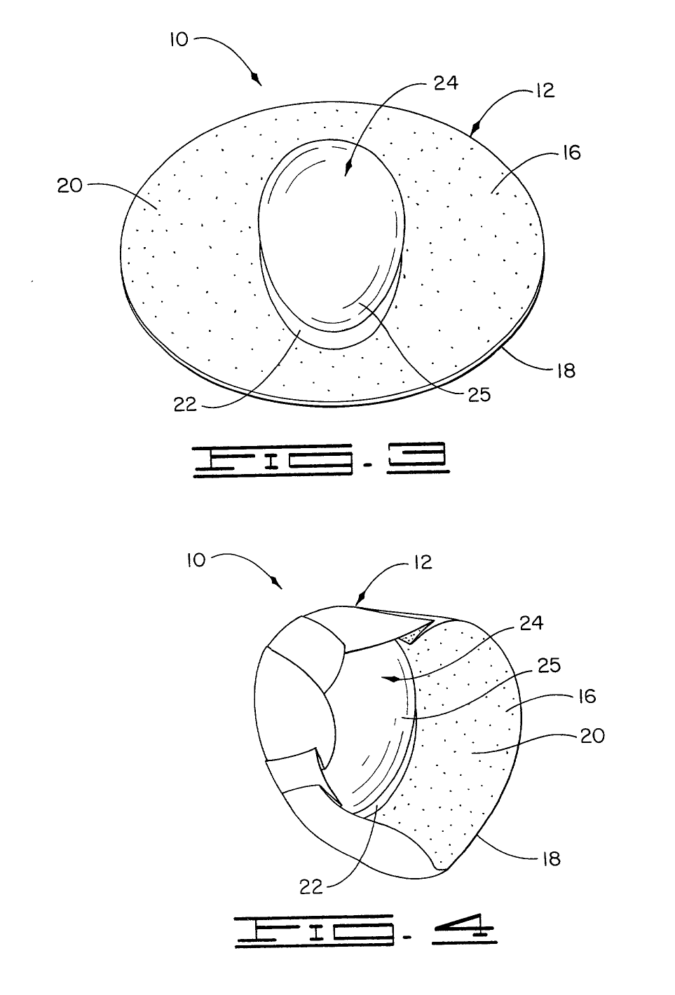

As described previously, the sheet of material 12 is wrapped about an easter egg 24. One such easter egg 24, having an outer surface 25, is shown in FIG. 3. The term “easter egg” includes, but not by way of limitation, a natural egg cooked or uncooked, or having only the shell. The term “easter egg” may also include any food or combinations of food products made in an egg shape, such as, but not by way of limitation, a candy egg. The term “easter egg” may include an artificial egg made of, but not by way of limitation, paper, plastic, foil, styrofoam, or any other material, or any combinations of material.

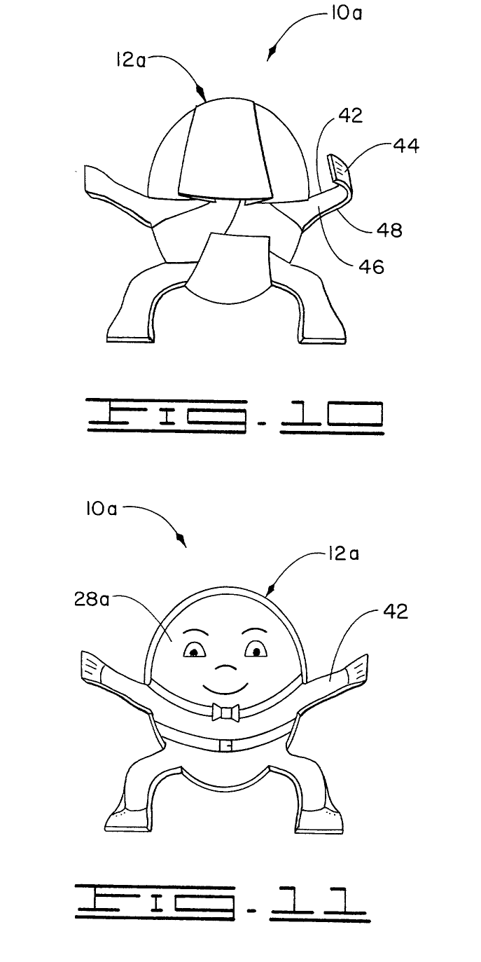

The sheet of material 12 is also wrappable about a holiday ornament 26. One such holiday ornament 26, having an outer surface 27, is illustrated in FIG. 9. The term “holiday ornament” includes, but not by way of limitation, Christmas ornaments for Christmas trees, such as, for example, but not by way of limitation, round ball ornaments. The term “holiday ornament” also includes other ornaments used decoratively for other holiday and festive occasions, such as, but not by way of limitation, Thanksgiving, Halloween, New Years, birthdays, anniversaries, and the like. The term “holiday ornament” includes not only the complete ornament, but also only the inner form of an ornament. In either instance, the holiday ornament may be made, but not by way of limitation, of any food or combinations of food products. The holiday ornament may also be made from, but not by way of limitation, paper, plastic, foil, metal, styrofoam, any other material, and any combination of materials.

It will be appreciated that the sheet of material 12 may be wrapped about a pre-wrapped easter egg 24 or holiday ornament 26 which already has an ornamentation thereon. Such an additional wrapping material 10 may be used to change the appearance of the easter egg 24 or holiday ornament 26. That is, the easter egg 24 and/or holiday ornament 26 receives a different decoration, which can be, if desired, for a different holiday or festive occasion. In another alternative, the wrapping material 10 is utilized to wrap the easter egg 24 or holiday ornament 26 so that the easter egg 24 and/or holiday ornament 26 may be customized with a particular design, name and/or pattern, for example.

Turning back to the sheet of material shown in FIG. 1, the sheet of material 12 in this embodiment is often constructed from two polypropylene films (a 20″×15″ sheet of Mobil 270 ABW white opaque film laminated to a 20″×15″ sheet of Mobil 220 AB clear film) having a thickness in a range of from less than about 1.0 mil to about 2.5 mils.

It will be understood, however, that the sheet of material 12 is constructed from any suitable material that is capable of being wrapped about an easter egg 24 or holiday ornament 26. In one embodiment, the sheet of material 12 comprises paper (untreated or treated in any manner), cellophane, foil, polymer film, fabric (woven or nonwoven or synthetic or natural), fiber, cling material, burlap, and any combination thereof.

The term “polymer film” means a man-made polymer such as a polypropylene or a naturally occurring polymer such as cellophane. A polymer film is relatively strong and not as subject to tearing (substantially non-tearable), as might be the case with paper or foil.

The sheet of material 12 may vary in color. Further, the sheet of material 12 may consist of designs or decorative patterns which are printed, etched, and/or embossed thereon using inks or other printing materials. An example of an ink which may be applied to the surface of the sheet of material 12 is described in U.S. Pat. No. 5,147,706 entitled “Water Based Ink On Foil And/Or Synthetic Organic Polymer” issued to Kingman on Sep. 15, 1992 and which is hereby incorporated herein by reference. In addition, the sheet of material 12 may have various colorings, coatings, flocking and/or metallic finishes, holographic images, or other decorative surface ornamentation applied separately or simultaneously or may be characterized totally or partially by pearlescent, neon, translucent, transparent, iridescent or the like, qualities. Each of the above-named characteristics may occur alone or in combination and may be applied to the upper and/or lower surface of the sheet of material 12. Moreover, each surface of the sheet of material 12 may vary in the combination of such characteristics. The sheet of material 12 may be opaque, translucent or partially clear or tinted transparent.

“Cling Wrap or Cling Material” when used herein means any material which is capable of connecting to a sheet of material and/or itself upon contacting engagement during the wrapping process and is wrappable about an item whereby portions of the cling material contactingly engage and connect to other portions of the wrapping material for generally securing a sheet of material wrapped about at least a portion of the item. This connecting engagement is preferably temporary in that the wrapping material may be easily removed without tearing same, i.e., the cling material “clings” to the wrapping material.

The cling material is constructed and treated if necessary, from polyethylene such as Cling Wrap made by Glad®, First Brands Corporation, Danbury, Conn. The thickness of the cling material will, in part, depend upon the thickness of the sheet of material utilized, i.e., generally, the thicker and therefore heavier sheet of material may require a thicker and therefore stronger cling material. The cling material will range in thickness from less than about 0.2 mils to about 10 mils, and preferably less than about 0.5 mils to about 2.5 mils and most preferably from less than about 0.3 mils to about 1 mils. However, any thickness of cling material may be utilized in accordance with the present invention which permits the cling material to function as described herein.

The sheet of material 12 used herein may further comprise at least one scent (not shown). Examples of scents utilized herein include, but not by way of limitation, floral scents (flower blossoms, or any portion of a plant), food scents (chocolate, sugar, fruits), herb or spice scents (cinnamon), and the like. Additional examples of scents include, but are not limited to, flowers (such as roses, daisies, lilacs), plants (such as fruits, vegetables, grasses, trees), foods (for example, candies, cookies, cake), food condiments (such as honey, sugar, salt), herbs, spices, woods, roots, leaves, needles, and the like, or any combination of the foregoing. Such scents are known in the art, and are commercially available.

The scent may be disposed upon the sheet of material 12 by spraying the scent thereupon, painting the scent thereupon, brushing the scent thereupon, lacquering the scent thereupon, immersing the sheet of material in a scent-containing liquid, exposing the sheet of material to scent-containing gas, forming scented elements, such, but not by way of limitation, beads, particles, and the like, which are incorporated in or disposed upon the sheet of material, or any combination of the foregoing.

The scent may be contained within a lacquer, or other liquid, before it is disposed upon the sheet of material 12. The scent may also be contained within a dye, ink, and/or pigment (not shown). Such dyes, inks and pigments are known in the art, and are commercially available, and may be disposed upon or incorporated in the sheet of material 12 by any method described herein or known in the art.

The sheet of material 12 may have design indicia 28 thereon. “Design indicia” is defined as herein means, but not by way of limitation, a pattern, numbers, letters, characters (such as, but not by way of limitation, comic or cartoon characters), and the like. “Design indicia” may include any geometric and/or asymmetric shape, or any combination of shapes, or any combination of the foregoing.

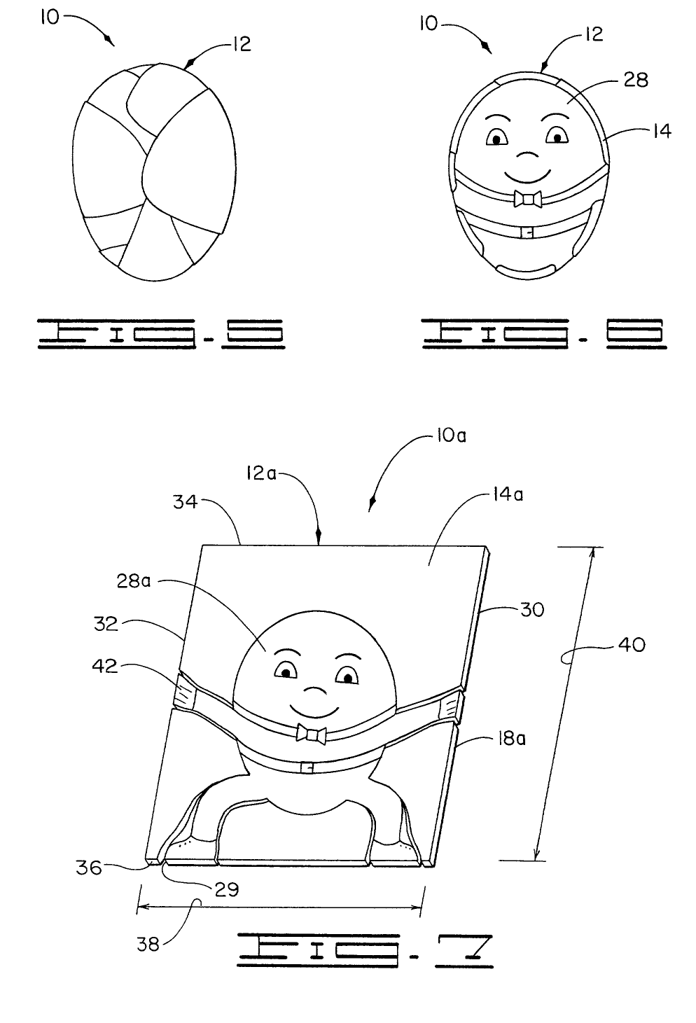

As shown in FIG. 1, the sheet of material 12 has design indicia 28 comprising a “Humpty Dumpty” design. An easter egg 24 (unwrapped natural egg) is provided. In a method of use, the sheet of material 12 is wrapped about the easter egg 24 as shown in FIGS. 3-6, with the bonding material 20 on the lower surface 16 of the sheet of material 12 disposed adjacent the outer surface 25 of the easter egg 24. When the sheet of material 12 is wrapped completely about the easter egg 24 as shown in FIGS. 4-6, the design indicia 28 on the sheet of material 12 comprising the “Humpty Dumpty” design is situated such that the design indicia 28 is well illustrated on one side of the outer surface 25 of the easter egg 24, as shown in FIG. 6, and the sheet of material 12 is gathered together in an overlapping manner on the opposite side of the outer surface 25 of the easter egg 24, as illustrated in FIG. 5.

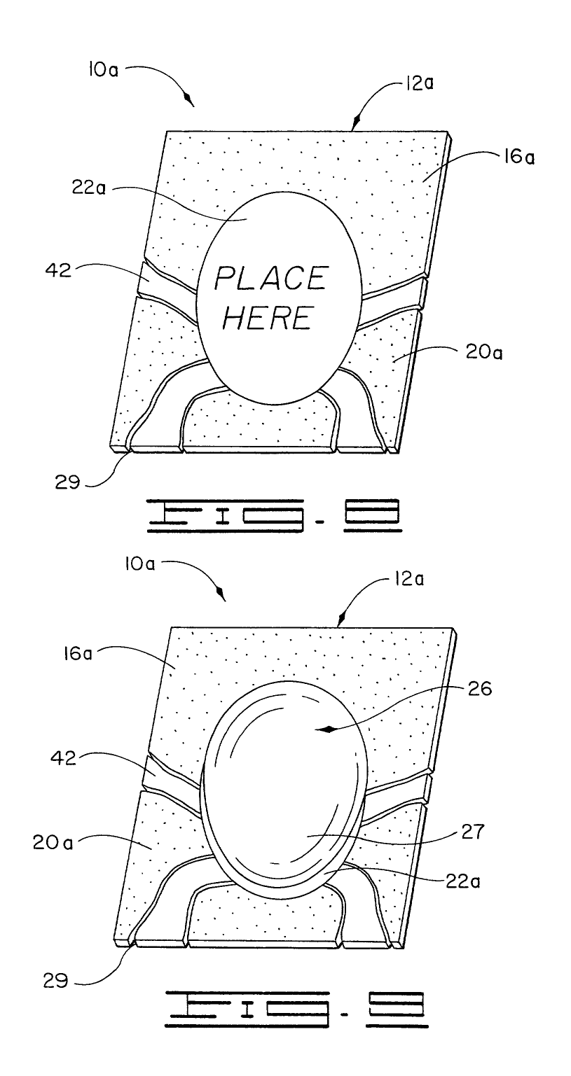

### The Embodiments and Methods of FIGS. 7-11

FIGS. 7-11 illustrate another embodiment of the present invention. FIG. 7 shows a sheet of material 12a which is constructed exactly like the sheet of material 12 described in detail before and shown in FIGS. 1-6, except that the sheet of material 12a is rectangular, and the sheet of material 12a has cut portions 29 in the sheet of material 12a, which will be described further below.

The outer periphery 18a of the sheet of material 12a comprises a first side 30, a second side 32, a third side 34 and a fourth side 36. The sheet of material 12a has a length 38 extending between the first and the second sides 30 and 32, respectively, of the sheet of material 12a. The sheet of material 12a also has a width 40 extending between the third and fourth sides 34 and 36, respectively, of the sheet of material 12a.

The sheet of material 12a has printed on the upper surface 14a a design indicia 28a comprising a “Humpty Dumpty”, but the arms and legs of the design indicia 28a are defined by cut portions 29 extending into the sheet of material 12a. When the sheet of material 12a is wrapped about the outer surface 27 of a holiday ornament 26 (in this instance, a ball form for a holiday ornament, illustrated schematically in FIGS. 9-11), the arms and legs of the “Humpty Dumpty” act as a plurality of extensions (only one extension designated by the numeral 42), and extend a distance away from the outer surface 27 of the holiday ornament 26.

The sheet of material 12 may also have one or more extensions 42 thereon or connected thereto. Each extension 42 may be integrally formed with the sheet of material 12, or may be formed from a separate sheet of material 12. Each extension 42 is formed with and/or connected to the sheet of material 12 such that the extension 42 extends a distance away from the sheet of material 12. It will be appreciated that each extension 42 has an upper surface 44, a lower surface 46 and an outer periphery 48. In the present instance, the embodiment shown in FIGS. 7-11 has a plurality of extensions (only one of the plurality designated by the numeral “42”).

The plurality of extensions 42 each have an upper surface 44, a lower surface 46 and an outer periphery 48. As illustrated in FIGS. 7-11, the plurality of extensions 42 are formed integrally with the sheet of material 12a. However, it will be appreciated that each of the plurality of extensions 42 may be formed from a separate extension sheet of material (not shown), and may be connected to the sheet of material 12a before, during or after the sheet of material 12a is used to wrap an object, such as an easter egg or a holiday ornament 26.

In a method of use, illustrated in FIGS. 9-11, the sheet of material 12a is wrapped about the holiday ornament 26 as shown in FIGS. 9-11, with the bonding material 20a on the lower surface 16a of the sheet of material 12a disposed adjacent the outer surface 25a of the holiday ornament 26. When the sheet of material 12a is wrapped completely about the holiday ornament 26, the design indicia 28a on the sheet of material 12a comprising the torso of the “Humpty Dumpty” design is situated such that the torso is well illustrated on one side of the outer surface 27 of the holiday ornament 26, as shown in FIG. 11, and the plurality of extensions 42 (the “arms” and “legs” of the “Humpty Dumpty” design) extend a distance away from the outer surface 27 of the holiday ornament 26, providing a different visual, aesthetic and decorative effect. The sheet of material 12a is gathered together in an overlapping manner on the opposite side of the outer surface 27 of the holiday ornament 26, as illustrated in FIG. 10.

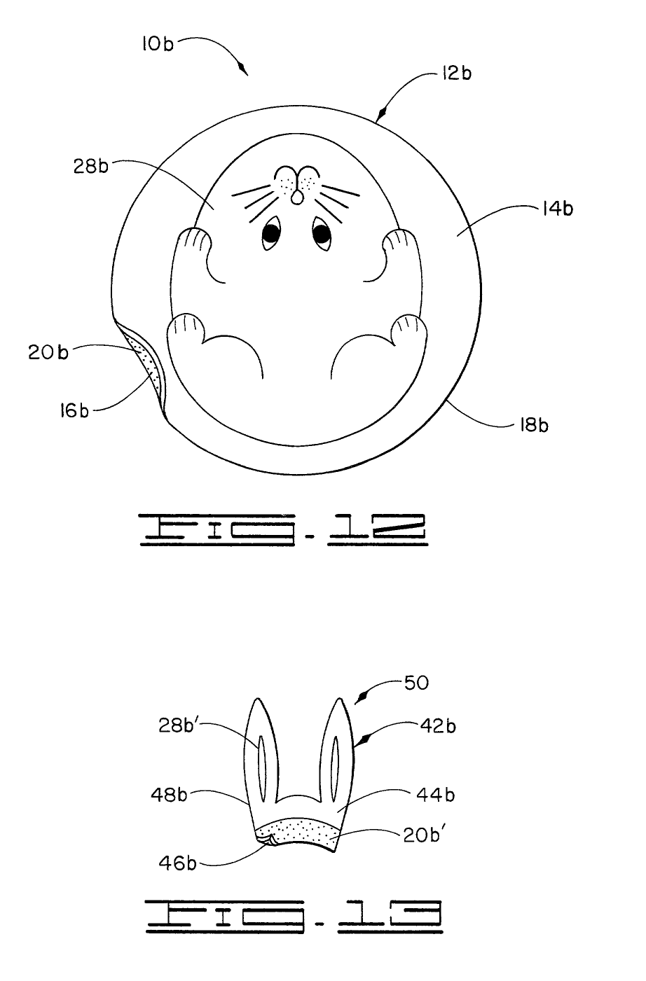

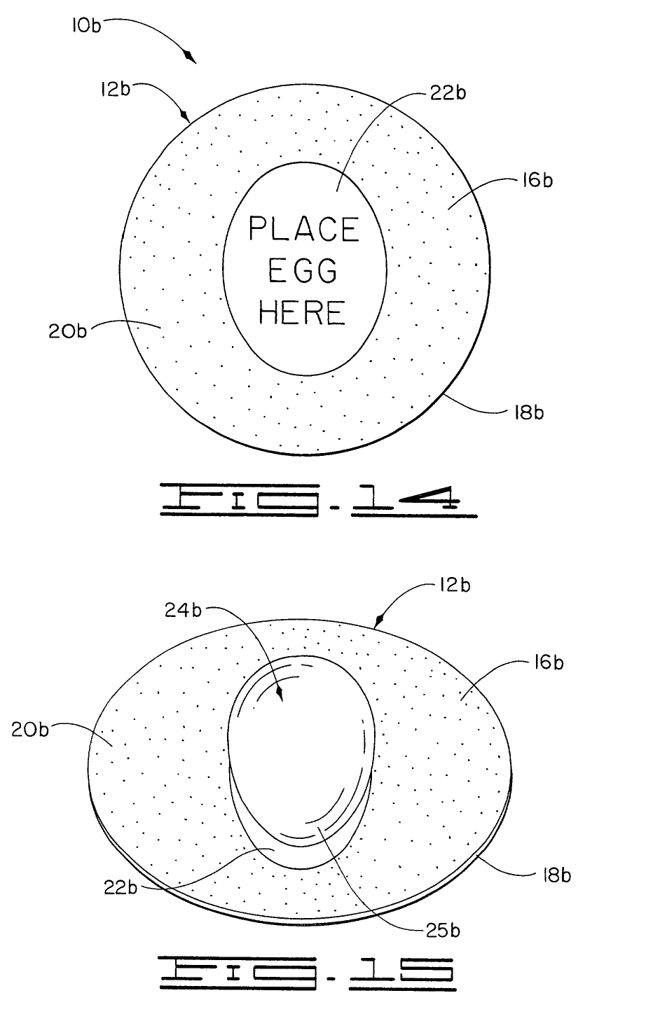

### The Embodiments and Methods of FIGS. 12-18

FIGS. 12-18 illustrate another embodiment of the present invention. FIG. 12 shows a sheet of material 12b which is constructed exactly like the sheet of material 12 and 12a described in detail before and shown in FIGS. 1-11, except that the sheet of material 12b is round (as shown in FIG. 1), and the sheet of material 12b has a different design forming the design indicia 28b, and the sheet of material 12b has an extension 42b formed from a second sheet of material 50.

As noted, the extension 42b is formed from a second sheet of material 50 which has an upper surface 44b, a lower surface 46b and an outer periphery 48b. It will be appreciated that the second sheet of material 50 forming the extension 42b may have any of the characteristics previously described herein for the sheet of material 12. The outer periphery of the extension 42b, in this embodiment, closely follows the design indicia 28b′, i.e., the “rabbit ears”. The second sheet of material 50 has a bonding material 20b′ thereon.

The sheet of material 12b has printed on the upper surface 14b a design indicia 28b comprising a “Rabbit” without ears. The “ears” of the rabbit are provided via the second sheet of material 50, as previously noted. The sheet of material 12b is wrapped about the outer surface 25b of an easter egg 24b, and then the extension 42b (the“ears” of the rabbit design), provided on the second sheet of material 50, are attached to the wrapped easter egg 24b in the anatomically appropriate area of the design, as illustrated in FIG. 17. The extension 42b extends a distance away from the outer surface 25b of the easter egg 24b, providing a more multidimensional effect of the design.

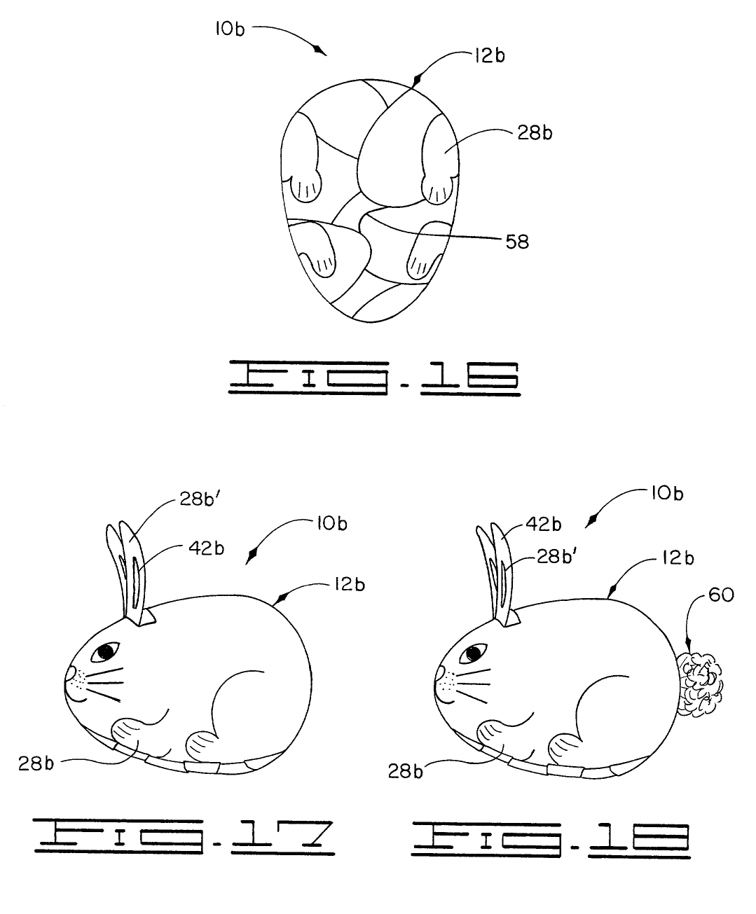

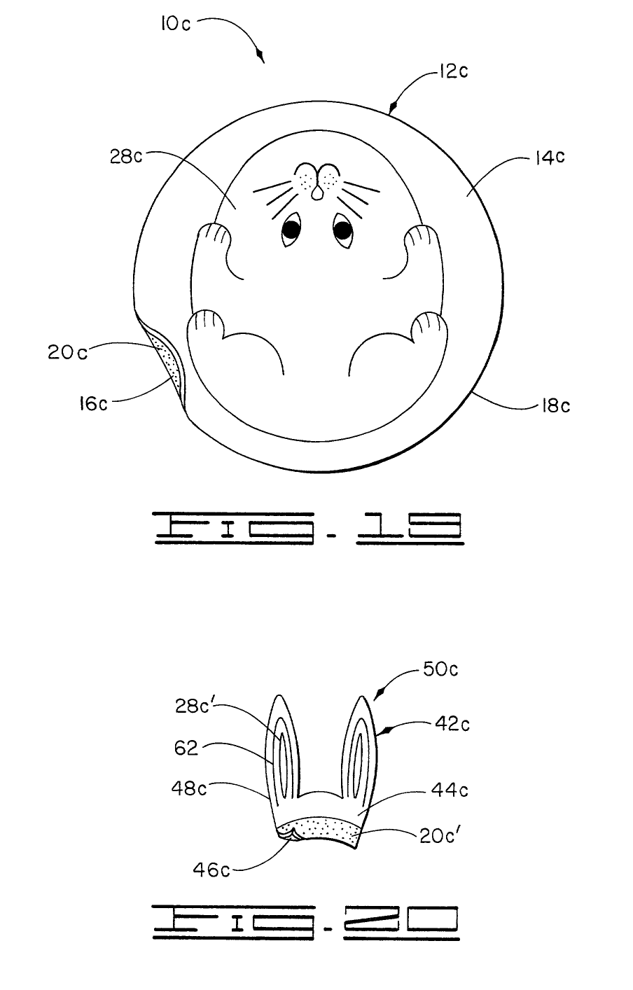

In a method of use, illustrated in FIGS. 15-18, the sheet of material 12b is wrapped about the easter egg 24b as shown in FIGS. 15-18, with the bonding material 20b on the lower surface 16b of the sheet of material 12b disposed adjacent the outer surface 25b of the easter egg 24b. When the sheet of material 12b is wrapped completely about the easter egg 24b, the design indicia 28b on the sheet of material 12b comprising the torso of the “Rabbit” design is situated such that the torso is well illustrated on one side of the outer surface 25b of the easter egg 24b, as shown in FIGS. 17-18. The extension 42b is situated on the wrapped easter egg 24b such that the extension 42b connects to the design indicia 28b at the top of the design of the rabbit's head, therefore connecting the extension 42b in an anatomically correct manner, showing the design indicia 28b′ of the extension 42b, namely, the rabbit ears, connected to the top of the design of the rabbit's head on the design indicia 28b. The extension 42b (the rabbit ears) extends a distance away from the outer surface 25b of the easter egg 24b, providing a different visual, aesthetic and decorative effect. The sheet of material 12b is gathered together in an overlapping manner on the opposite side of the outer surface 25b of the easter egg 24b, creating a closure location 58, as illustrated in FIG. 16.

In a further alternative, a closure decoration 60, such as, for example only, a cotton ball (representing a rabbit's tail) is added to the sheet of material 12b on the easter egg 24b, in the correct anatomical location, as shown in FIG. 18. It will be appreciated that other types of closure decorations 60 may be added to each of these embodiments, and others will suggest themselves. Such decorations 60 include, but are not limited to, hats, clothing, jewelry, buttons, hair, eyes, ears, and the like. It will be understood that “closure decoration”, as used herein, may is a decoration which may be used over the closure location 58. Alternatively, however, the closure decoration 60 is used to complete the overall design, and is therefore not limited to creating and/or holding the sheet of material in an enclosing position.

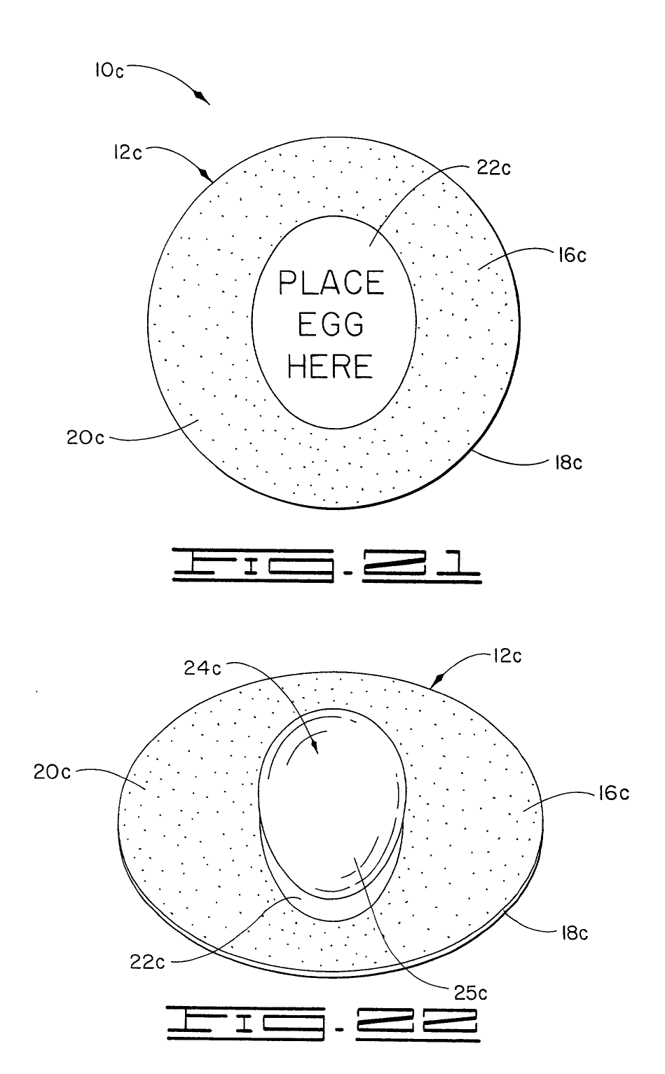

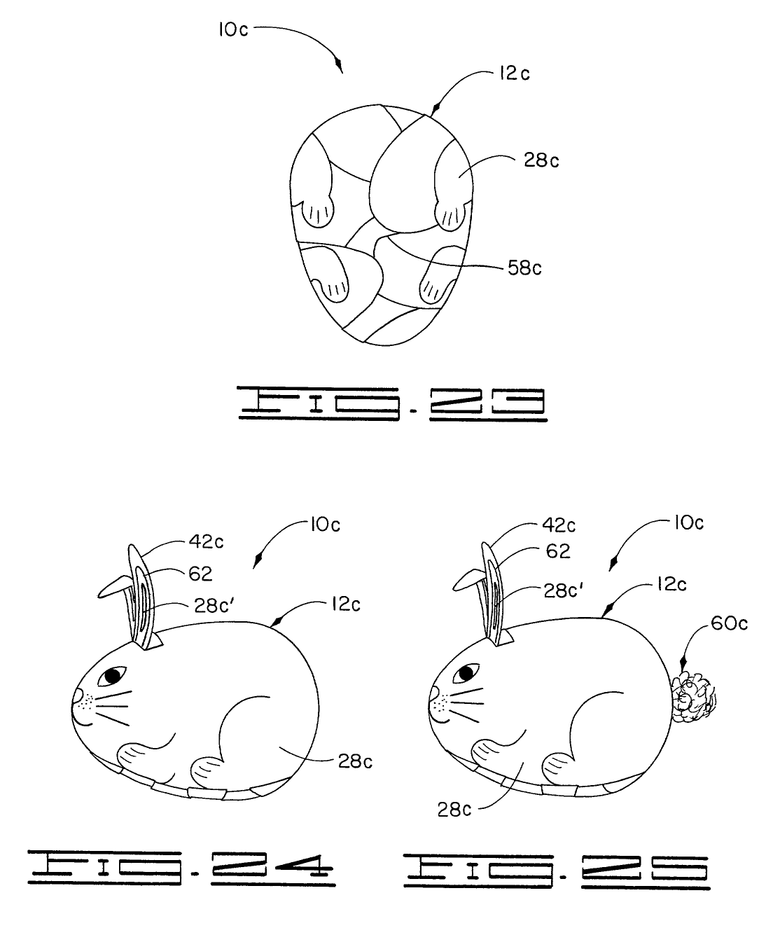

### The Embodiments and Methods of FIGS. 19-25

FIGS. 19-25 illustrate another embodiment of the present invention. FIG. 19 shows a sheet of material 12c which is constructed exactly like the sheet of material 12b described in detail before and shown in FIGS. 12-18.

The extension 42c is constructed exactly like the extension 42b described in detail and illustrated previously in FIG. 13, except that a shape sustaining element 62 is connected to the upper surface 44c of the second sheet of material 50c.

“Shape sustaining element”, as used herein, means an element formed from, but not by way of limitation, wire, metal, plastic, fiber, wood, cardboard, and the like, which will sustain a shape.

In a method of use, illustrated in FIGS. 22-25, the sheet of material 12c is wrapped about the easter egg 24c in the same method described previously, and shown in FIGS. 15-18. Similarly, the extension 42c is situated on the wrapped easter egg 24c such that the extension 42c connects to the design indicia 28c at the top of the design of the rabbit's head, therefore connecting the extension 42c in an anatomically correct manner, showing the design indicia 28c′ of the extension 42c, namely, the rabbit ears, connected to the top of the design of the rabbit's head on the design indicia 28c. The shape sustaining element 62 in the extension 42c (the rabbit ears) may be positioned to extend the extension 42c a distance away from the outer surface 25c of the easter egg 24c. Further, the shape sustaining element 62 may be positioned to provide a different visual, aesthetic and decorative effect. It will be appreciated that the shape sustaining element may, alternatively, be connected to the sheet of material 12c, for shaping the sheet of material 12c, or any portion of the sheet of material 12c (not shown). In a further alternative, the shape sustaining element 62 may be connected to both the sheet of material 12c and the extension 42c (not shown), or may form a plurality of shape sustaining elements 62 which are connected to the sheet of material 12c and/or the extension 42c (not shown).

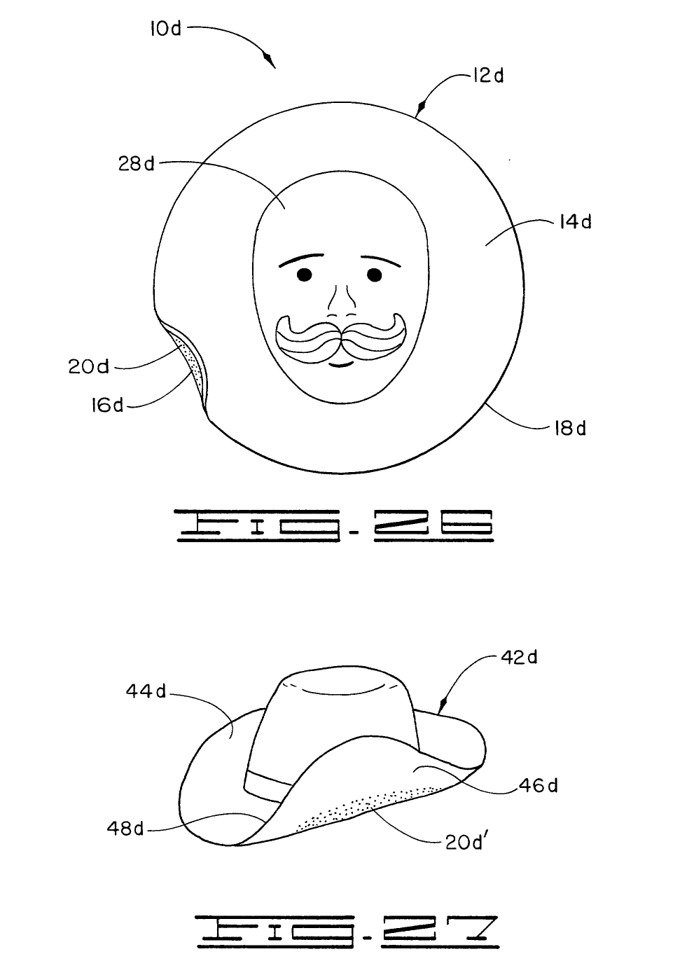

A closure decoration 60c may be used, as shown and described previously herein, as a decorative completion element, as illustrated in FIG. 25 (a “rabbit's tail”).

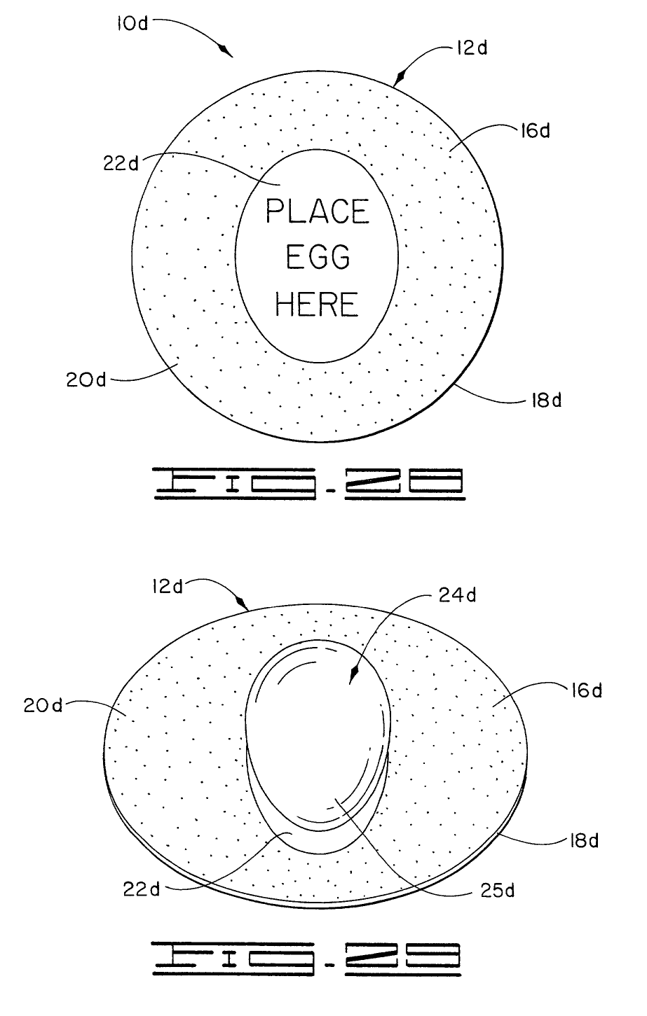

### The Embodiments and Methods of FIGS. 26-31

FIGS. 26-31 illustrate another embodiment of the present invention. FIG. 26 shows a sheet of material 12d which is constructed exactly like the sheet of material 12b and 12c described in detail before and shown in FIGS. 12 and 19, except that the sheet of material 12d has a design indicia 28d comprising a man's face having a mustache.

An extension 42d is provided, however, the extension 42d has no design indicia thereon, and is preformed into a predetermined shape, in this instance, a western-style hat. In addition, in this instance, at least a portion of the lower surface 46d of the extension 42d has a bonding material 20d′ thereon.

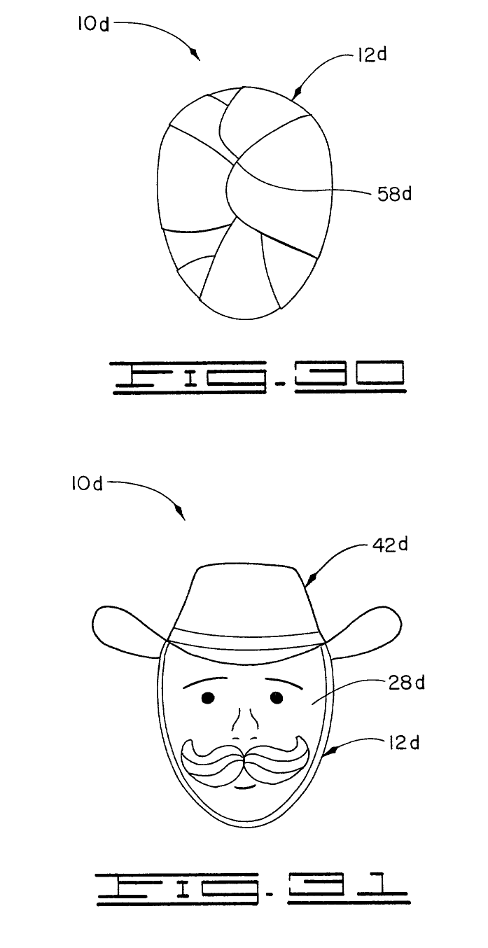

In a method of use, illustrated in FIGS. 29-31, the sheet of material 12d is wrapped about an easter egg 24d as shown in FIGS. 29-31, with the bonding material 20d on the lower surface 16d of the sheet of material 12d disposed adjacent the outer surface 25d of the easter egg 24d. When the sheet of material 12d is wrapped completely about the easter egg 24d, the design indicia 28d on the sheet of material 12d comprising a face having a mustache is situated such that the face is well illustrated on one side of the outer surface 25d of the easter egg 24d, as shown in FIG. 31. The extension 42d comprising the hat is then connected to the wrapped easter egg 24d such that the extension 42d connects to the design indicia 28d at the top of the design of the face, namely, the top of the head, therefore connecting the extension 42d in a recognizable manner (a head with a face having a mustache thereon having a hat on the top of the head). The extension 42d (the hat) extends a distance away from the outer surface 25d of the easter egg 24d, providing a different visual, aesthetic and decorative effect. The sheet of material 12d is gathered together in an overlapping manner on the opposite side of the outer surface 25d of the easter egg 24d, creating a closure location 58d, as described previously herein and illustrated in FIGS. 16, 23 and 30.

It will be appreciated that all easter eggs or holiday ornaments shown and described herein will have a closure location and may, optionally, have one or more closure decorations as described previously herein.

Further, the easter eggs, or holiday ornaments, (“holiday items”) may be collected in a bag made from any material described herein. The bag often used will comprise two square or rectangular sheets of material sealed together at the sides around three out of four sides. The unsealed side forms an opening which may be closed via bonding material, or via a pressed frictional engagement. It will be appreciated that other forms of bags or packages may also be used to collect and/or hold the holiday items.

Changes may be made in the embodiments of the invention described herein, or in parts or elements of the embodiments described herein, or in the sequence of steps of the methods described herein, without departing from the spirit and/or scope of the invention as defined in the following claims.

What is claimed is:

1. A decorative cover for a holiday item, comprising:
a sheet of material having an upper surface, a lower surface and an outer periphery, at least one surface having forming indicia thereon and at least one other surface having design indicia thereon; and
a holiday item;
wherein the holiday item is disposed on the sheet of material via instructions provided by the forming indicia, and wherein the sheet of material is wrapped about the holiday item such that the holiday item is substantially surrounded and enclosed by said sheet of material thereby forming a decorative cover for the holiday item.

2. The decorative cover of claim 1, wherein the holiday item comprises an easter egg.

3. The decorative cover of claim 1, wherein the holiday item comprises a holiday ornament.

4. The decorative cover of claim 1, wherein the sheet of material comprises a bonding material.

5. The decorative cover of claim 4, wherein the bonding material comprises an adhesive bonding material.

6. The decorative cover of claim 4, wherein the bonding material comprises an cohesive bonding material.

7. The decorative cover of claim 1 wherein the sheet of material further comprises at least one extension.

8. The decorative cover of claim 7 wherein the extension further comprises a shape sustaining element.

9. The decorative cover of claim 1, wherein at least one additional sheet of material is connected to the sheet of material to form at least one extension.

10. The decorative cover of claim 9 wherein the extension further comprises a shape sustaining element.

11. The decorative cover of claim 1, wherein the decorative cover further comprises a closure decoration.

12. The decorative cover of claim 1 wherein the sheet of material is selected from the group consisting of paper, polymer film, fiber, foil, cellophane, cloth, burlap, and any combination thereof.

13. The decorative cover of claim 1 wherein the sheet of material has a thickness in a range from about 0.1 mils to about 10 mils.

14. The decorative cover of claim 1 wherein the sheet of material has a thickness in a range from about 0.1 mils to about 5 mils.

15. A decorative cover used for packaging a holiday item, comprising:
a sheet of material having an upper surface, a lower surface and an outer periphery, at least one surface having forming indicia thereon and at least one other surface having design indicia thereon;
wherein when a holiday item is disposed on the sheet of material via instructions provided by the forming indicia, and wherein when the sheet of material is wrapped about the holiday item, the holiday item is substantially surrounded and enclosed by said sheet of material thereby forming a decorative cover for the holiday item.

16. The decorative cover of claim 15, wherein the holiday item comprises an easter egg.

17. The decorative cover of claim 15, wherein the holiday item comprises a holiday ornament.

18. The decorative cover of claim 15, wherein the sheet of material comprises a bonding material.

19. The decorative cover of claim 18, wherein the bonding material comprises an adhesive bonding material.

20. The decorative cover of claim 18, wherein the bonding material comprises an cohesive bonding material.

21. The decorative cover of claim 15 wherein the sheet of material further comprises at least one extension.

22. The decorative cover of claim 21 wherein the extension further comprises a shape sustaining element.

23. The decorative cover of claim 15, wherein at least one additional sheet of material is connected to the sheet of material to form at least one extension.

24. The decorative cover of claim 23 wherein the extension further comprises a shape sustaining element.

25. The decorative cover of claim 15, wherein the decorative cover further comprises a closure decoration.

26. The decorative cover of claim 15 wherein the sheet of material is selected from the group consisting of paper, polymer film, fiber, foil, cellophane, cloth, burlap, and any combination thereof.

27. The decorative cover of claim 15 wherein the sheet of material has a thickness in a range from about 0.1 mils to about 5 mils.

28. The decorative cover of claim 15 wherein the sheet of material has a thickness in a range from about 0.1 mils to about 5 mils.

29. A method of providing and wrapping a holiday item in a decorative cover, comprising the steps of:
providing a sheet of material having an upper surface, a lower surface and an outer periphery, at least one surface having forming indicia thereon and at least one other surface having design indicia thereon;
providing a holiday item;
disposing the holiday item on the surface having forming indicia thereon;
positioning the holiday item via the forming instructions; and
wrapping the sheet of material about the holiday item such that the holiday item is substantially surrounded and enclosed by said sheet of material thereby forming a decorative cover for the holiday item.

30. The method of claim 29 wherein in the step of providing a holiday item, the holiday item comprises an easter egg.

31. The method of claim 29 wherein in the step of providing a holiday item, the holiday item comprises a holiday ornament.

32. The method of claim 29 wherein in the step for providing a sheet of material, the sheet of material comprises a bonding material.

33. The method of claim 32 wherein the bonding material comprises an adhesive bonding material.

34. The method of claim 32 wherein the bonding material comprises an cohesive bonding material.

35. The method of claim 29 wherein in the step of providing a sheet of material, the sheet of material further comprises at least one extension.

36. The method of claim 35 wherein the extension further comprises a shape sustaining element.

37. The method of claim 29 wherein in the step of providing a sheet of material, at least one additional sheet of material is connected to the sheet of material to form at least one extension.

38. The method of claim 37 wherein the extension further comprises a shape sustaining element.

39. The method of claim 29 wherein in the step of wrapping the sheet of material about the holiday item and forming the decorative cover, the decorative cover further comprises a closure decoration.

40. The method of claim 29 wherein in the step of providing a sheet of material, the sheet of material is selected from the group consisting of paper, polymer film, fiber, foil, cellophane, cloth, burlap, and any combination thereof.

41. The method of claim 29 wherein in the step of providing a sheet of material, the sheet of material has a thickness in a range from about 0.1 mils to about 10 mils.

42. The method of claim 29 wherein in the step of providing a sheet of material, the sheet of material has a thickness in a range from about 0.1 mils to about 5 mils.
